(19) United States
(12) Patent Application Publication
(10) Pub. No.: US 2004/0165333 A1
(43) Pub. Date: Aug. 26, 2004

(54) Magnetic-auto-static-grounding-wire

(76) Inventor: Ilio Bertolami, Saturna Island (CA)

Correspondence Address: Ilio Bertolami, Box 84, Saturna Isl, BC, V0N 2Y0, CA

(21) Appl. No.: 10/371,095

(22) Filed: Feb. 24, 2003

(51) Int. Cl. H01T 23/00

(52) U.S. Cl. 361/230

(57) ABSTRACT

This invention is simply the utilization of a permanent magnet as a means of attaching a flexible wire to the iron frame of a vehicle. The wire, pulled downward by gravity and dragging on the ground, dissipates static as it builds in the vehicle, which is naturally insulated by the effect of the non-conductive tires. The benefit of this system is the simplicity of use and flexibility of attachment sites.

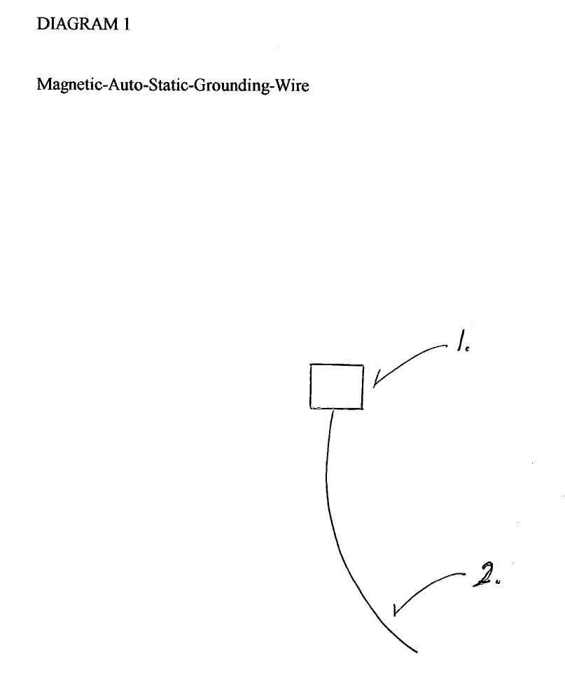

### CROSS REFERENCE TO RELATED APPLICATION

Not Applicable

### STATEMENT REGARDING FED. SPONSORED R7D

Not Applicable

### REFERENCE TO SEQUENCE LISTING

Not Applicable

### BACKGROUND OF THE INVENTION

Present grounding systems utilized in the auto, truck and other household and industrial applications simply attach the grounding wire, by mechanical means, to the device being protected. Application in the vehicle industry generally utilizes the mechanically attached grounding-wire dragging on the ground, usually as the vehicle comes to a stop. The MAGNETIC-AUTO-GROUNDING-WIRE system replaces the need for mechanical attachment by utilizing a magnet as the attachment-contact. The benefits consists of ease of attachment, mobility, and more readily adapts to permanent or short-term applications.

### BRIEF SUMMARY OF THE INVENTION

The essence of the invention is the utilization of a permanent magnet as a means of attachment. Functions as other wire grounding systems in that it simply connects a wire from the iron frame of a vehicle or other iron bodies, to the ground. Unlike other products that attach the wire to the frame by mechanical means, this system utilizes a permanent magnet to attach the wire to the iron structure.

### BRIEF DESCRIPTION OF THE DRAWING

Diagram 1

1. Permanent magnet

2. Flexible insulated wire

### DETAILED DESCRIPTION

The device consists of two primary parts, a powerful permanent magnet with an attached flexible insulated wire.

1. What I claim as my invention is the utilization of a permanent magnet connected to a grounding wire as a means of attachment to the vehicle or device to be protected by static discharge.
